(19) United States
(12) Patent Application Publication
(10) Pub. No.: US 2020/0070310 A1
(43) Pub. Date: Mar. 5, 2020

(54) METAL HYBRID GRINDING WHEEL WITH COATED FILLER PARTICLES

(71) Applicant: 3M INNOVATIVE PROPERTIES COMPANY, St. Paul, MN (US)

(72) Inventors: Janusz HAJDUK, Wallington, NJ (US); Brian D. GOERS, Minneapolis, MN (US); Richard HUPPERTZ, Aachen (DE); Badri VEERARAGHAVAN, Woodbury, MN (US)

(21) Appl. No.: 16/461,103

(22) PCT Filed: Nov. 9, 2017
(86) PCT No.: PCT/US2017/060816

§ 371 Date: May 15, 2019

Related U.S. Application Data
(60) Provisional application No. 62/423,846, filed on Nov. 18, 2016.

(51) Int. Cl. B24D 3/08; B24D 3/34

(52) U.S. Cl. CPC B24D 3/08; B24D 18/0009; B24D 3/342

(57) ABSTRACT

Various embodiments disclosed relate to an abrasive article. The abrasive article includes a metallic matrix component, an abrasive particle component dispersed within the metallic matrix component; and a filler particle component dispersed within the metallic matrix component. A portion of the filler particle component is at least partially coated by a first metallic layer. Additionally, a hardness of the abrasive particle component is greater than a hardness of the filler particle component

### BACKGROUND

One measure of the performance of an abrasive article is the integrity of the bonds formed the components that form the abrasive article. If the bonds are too weak, then the abrasive article can be prone to premature failure. However, given the different types of components that can be found in the abrasive article, it can be difficult to ensure good bonding throughout the article.

### SUMMARY OF THE DISCLOSURE

According to various embodiments, the present disclosure provides an abrasive article. The abrasive article includes a metallic matrix component, an abrasive particle component dispersed within the metallic matrix component; and a filler particle component dispersed within the metallic matrix component. A portion of the filler particle component is at least partially coated by a first metallic layer. Additionally, a hardness of the abrasive particle component is greater than a hardness of the filler particle component.

According to various embodiments, the present disclosure provides a method of using an abrasive article, in which the abrasive article is a wheel. The abrasive article includes a metallic matrix component, an abrasive particle component dispersed within the metallic matrix component, and a filler particle component dispersed within the metallic matrix component. A portion of the filler particle component is at least partially coated by a first metallic layer. Additionally, a hardness of the abrasive particle component is greater than a hardness of the filler particle component. A substrate is contacted with the wheel and the wheel is rotated with respect to the substrate.

According to various embodiments, a method of forming an abrasive article includes at least partially coating a filler particle component with a first metallic layer. The method further includes mixing the at least partially coated filler particle component, the metallic matrix, and a resin to form a mixture. An abrasive particle component is added to the mixture and the mixture is mixed further. The mixture is then contacted with a mold.

The abrasive article of the disclosure includes various advantages, some of which are unexpected. For example, according to some embodiments of the present disclosure, the bond between the filler particles of the filler particle component and the metal matrix component is increased in strength compared to a corresponding article that does not include the at least partially coated filler particle component. According to some embodiments of the present disclosure, during operation of the abrasive article, less power is consumed when using the article to produce a total cut of produce a total cut of 8 mm³/mm/sec compared to production of the same total cut under the same conditions using a corresponding abrasive article having less or none of the at least partially coated filler particle component. In various embodiments, due to at least the higher strength of the bond structure, a larger amount of filler particles can be incorporated into the bond structure, resulting in a more free cutting structure that utilizes less power in the grinding operation. In various embodiments, when utilizing lower amounts of coated filler particles, a stronger structure can be created resulting in a structure that retains its form longer and also has lower power requirements during cutting as compared to an abrasive article with equivalent amounts of uncoated filler particles.

### BRIEF DESCRIPTION OF THE FIGURES

In the drawings, which are not necessarily drawn to scale, like numerals describe substantially similar components throughout the several views. The drawings illustrate generally, by way of example, but not by way of limitation, various embodiments discussed in the present document.

FIG. 1 is shows a grinding wheel, in accordance with various embodiments.

FIG. 2 is a sectional view of a portion of the grinding wheel, in accordance with various embodiments.

FIG. 3 is a graph showing a power profile of various abrasive articles with the spindle power shown on the y-axis in KW.

FIG. 4 is another graph showing a power profile of various abrasive articles with the spindle power shown on the y-axis in KW.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

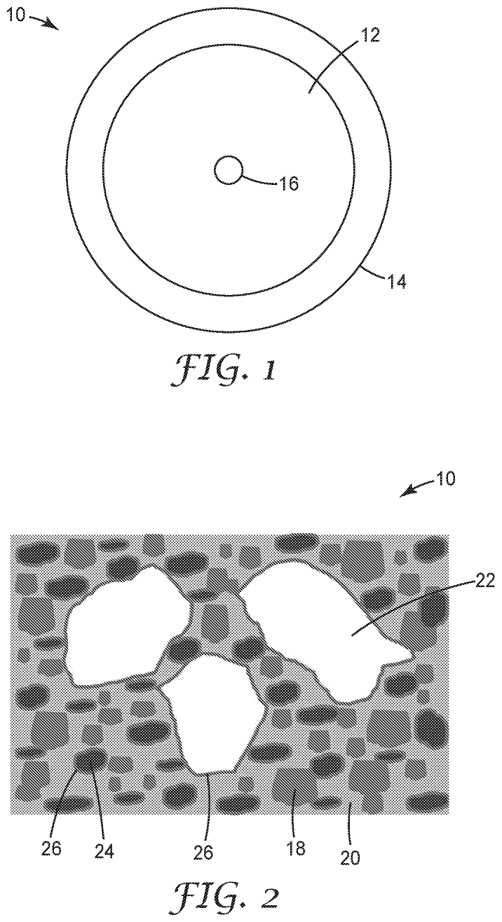

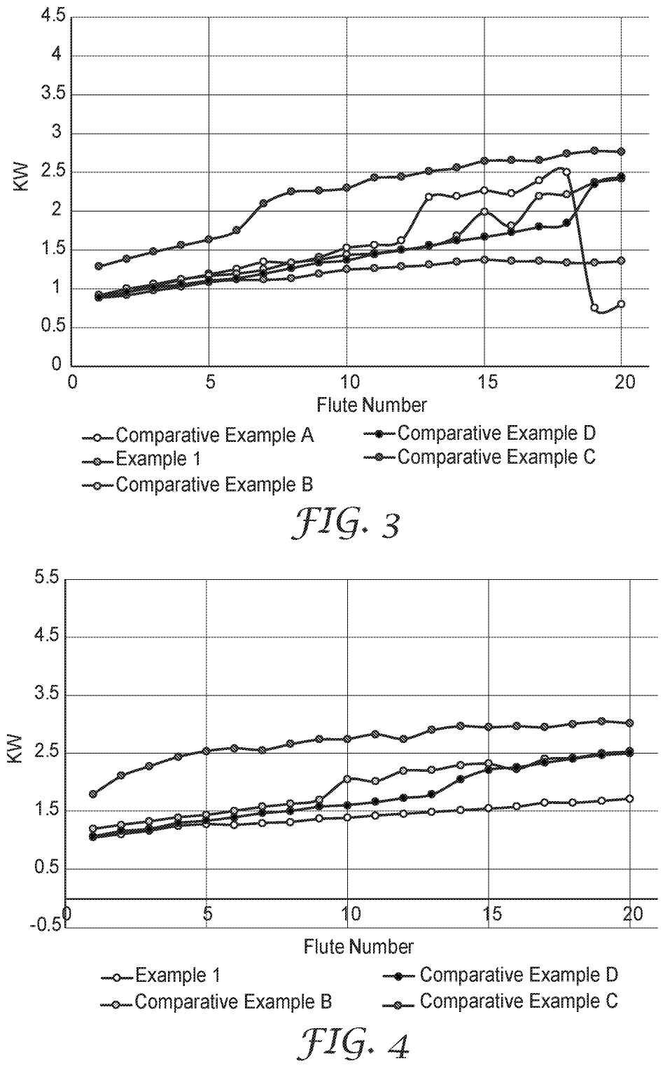

FIGS. 1 and 2, show grinding wheel 10. In some applications, grinding wheel 10 can be used for machining hard and/or brittle materials such as tungsten carbide. Such materials can be present in work pieces for tools such as for example drills or milling tools.

As shown in FIG. 1, grinding wheel 10 includes core 12 and abrasive article 14. As discussed herein, abrasive article 14 can be formed form abrasive particles and filler particles disposed in a metallic matrix and a resin. Abrasive article 14 forms a rim circumscribing core 12. Core 12 can be made of a less abrasive, or in some circumstances, less expensive material such as steel or some other metal. Alternatively, core 12 can be made of, for example, a polymeric material. Core 12 can also include more than one material. For example, core 12 can be made partially of metal such as steel or aluminum and partially of a polymeric material. Core 12 can give structural support to abrasive article 14. Core 12 can be provided with through-hole or cavity 16 such that grinding wheel 10 can be mounted on a spindle (not shown) for rotary movement.

FIG. 2 shows a sectional view of abrasive article 14. As shown, abrasive article 14 includes a metallic matrix component that includes metallic members such as bronze particles 18 and alloy 20. The metallic matrix component can act as a bonding agent that holds the abrasive particle component and the filler particle component together. The metallic matrix component can also include a polymeric bonding agent that can include a polyimide. Abrasive article 14 further includes an abrasive particle component, which includes abrasive particles 22 embedded within the metallic matrix component. Abrasive article 14 further includes a filler particle component which includes filler particles 24 embedded within the metallic matrix component. Abrasive particles 22 have a higher hardness than filler particles 24. As shown, filler particles 24 are at least partially coated by first metallic layer 26.

Each component accounts for a different volume percent (vol %) and weight percent (wt %) of abrasive article 14. For example, the metallic matrix component can range from about 10 wt % to about 50 wt % of abrasive article 14, or from about 20 wt % to about 40 wt % of abrasive article 14, or less than, equal to, or greater than 15 wt %, 20, 25, 30, 35, 40, 45 wt % of abrasive article 14. Additionally, the metallic matrix component can range from about 40 vol % to about 90 vol % of abrasive article 14, or from about 50 vol % to about 80 vol % of abrasive article 14, or less than about, equal to about, or greater than about, 40 vol %, 45, 50, 55, 60, 65, 70, 75, 80, or 85 vol % of abrasive article 14.

As shown in FIG. 2, the metallic matrix component includes a plurality of metallic particles. On average, a hardness of about 50 wt % to about 100 wt %, or 90 wt % to about 100 wt %, or less than, equal to, or greater than 55 wt %, 60, 65, 70, 75, 80, 85, 90, or 95 wt % of the metallic particles is lower than the hardness of the abrasive particle component. In some examples the hardness of the individual metallic particles ranges from about 2 Mohs hardness to about 8 Mohs hardness, or from about 4 Mohs hardness to about 6 Mohs hardness, or less than, equal to, or greater than 3 Mohs hardness, 4, 5, 6, or 7 Mohs hardness.

The individual metallic particles can include one or more different metals, alloys, or combinations thereof. For example, the metallic particles of the metallic matrix component can include elemental tin, elemental silver, elemental copper, bronze, alloys thereof, or mixtures thereof.

In some examples, the metallic particles are 100 wt % bronze. In other examples the metallic particles can include other metals such that bronze ranges from about 10 wt % to about 50 wt % of abrasive article 14, or from about 20 wt % to about 30 wt % of abrasive article 14, or less than, equal to, or greater than 15 wt %, 20, 25, 30, 35, 40, or 45 wt % of abrasive article 14. In terms of the weight percent of the abrasive article 14, the bronze can range from about 10 vol % to about 40 vol %, or from about 20 vol % to about 50 vol % of abrasive article 14, or less than, equal to, or greater than 15 vol %, 20, 25, 30, or 35 vol % of abrasive article 14. The bronze can include one or more of various different grades of bonze. Examples of suitable grades of bronze include 50/50 bronze, 40/60 bronze, and 60/40 bronze.

In addition to bronze, other metals that can be included in the metallic matrix include an alloy of elemental silver, elemental copper, and elemental tin. The alloy can be used in conjunction with another metal such as bronze to form the metallic matrix component. The alloy can also be used alone so that it accounts for 100% of the metallic matrix component. The alloy can range from about 10 wt % to about 50 wt % of abrasive article 14 or from about 20 wt % to about 50 wt % of abrasive article 14, or from about 15 wt %, 20, 25, 30, 35, 40, or 55 wt % of abrasive article 14. Additionally, the alloy can range from about 10 vol % to about 50 vol % of abrasive article 14 or from about 20 vol % to about 40 vol %, or less than, equal to, or greater than 15 vol %, 20, 25, 30, 35, 40, or 45 vol % of abrasive article 14.

The respective amounts of elemental silver, elemental copper, and elemental tin within the alloy can be selected from various amounts. For example the elemental silver can range from about 1 wt % to about 20 wt % of the alloy, or from about 5 wt % to about 15 wt % of the alloy, or less than, equal to, or greater than 5 wt %, 10, or 15 wt % of the alloy. The elemental copper can range from about 30 wt % to about 60 wt % of the alloy, or about 40 wt % to about 50 wt % of the alloy, or less than, equal to, or greater than 35 wt %, 40, 45, 50, or 55 wt % of the alloy. The elemental tin can range from about 30 wt % to about 60 wt % of the alloy, or from about 40 wt % to about 50 wt % of the alloy, or less than, equal to, or greater than 35 wt %, 40, 45, 50, or 55 wt % of the alloy. In some examples, the alloy is 10 wt % elemental silver, 45 wt % elemental copper, and 45% elemental tin.

The metallic matrix component can further include a polymeric bonding agent that is mixed together with the metal particles such that the polymeric bonding agent and the metal particles form a connected network The use of a polymeric agent can allow fine tuning of the properties of the metallic matrix to adapt it to different kinds of abrasive particles. In some examples, the polymeric bonding agent can be a polyimide or a composition including a polyimide. One benefit of using polyimide is that it heat resistant and can withstand the high temperatures during formation of the abrasive article.

The filler particle component is dispersed within the metal matrix component. The filler particle component can have lubricating properties that can aid with grinding. For example, the filler particle component can facilitate better contact with a substrate, which can lower the power draw of a device using the abrasive article. The filler particle component can range from about 5 vol % to about 40 vol % of abrasive article 14, or from about 15 vol % to about 30 vol % of abrasive article 14, or less than, equal to, or greater than 10 vol %, 15, 20, 25, 30, or 35 vol % of abrasive article 14. Additionally, the filler particle component can range from about 2 wt % to about 20 wt % of abrasive article 14, or from about 5 wt % to about 10 wt % of abrasive article 14, or less than, equal to, or greater than 5 wt %, 10, or 15 wt % of abrasive article 14. The filler particle component can include a plurality of filler particles 24. On average, a hardness of the each of filler particles 24 is less than those of the abrasive particle component. For example, the hardness of filler particles 24, on average, can range from about 0.5 Mohs hardness to about 8 Mohs hardness, or from about 0.5 Mohs hardness to about 4 Mohs hardness, or about 1 Mohs hardness, 2, 3, 4, 5, 6, or 7 Mohs hardness. Examples of suitable filler particles 24 include graphite particles, boron nitride particles (e.g., hexagonal boron nitride particles), glass particles, silicon nitride particles, binder coke particles, or mixtures thereof.

In some examples of abrasive article 14, the filler particle component is mostly formed from graphite particles. For example about 50 wt % to about 100 wt %, or about 90 wt % to about 100 wt %, or less than, equal to, or greater than 55 wt %, 60, 65, 70, 75, 80, 85, 90, or 95 wt % of filler particles 24 are graphite particles.

Graphite, along, with other filler particles is a good lubrication agent. Good adhesion between the filler particles 24 and the metallic matrix component can facilitate adequate performance of the abrasive article. A potential problem, however, is that as filler particles 24 are mixed with the metallic matrix component and the abrasive particle component, the bond between filler particles 24 and the matrix component can be weakened. For example, graphite filler particles can smear when they contact the abrasive particle component or the metallic matrix component. The smearing of graphite can weaken adhesion between the components of abrasive article 14. However, at least partially coating filler particles 24 with first metallic layer 26 can promote good adhesion with the metallic matrix component, while substantially preventing smearing.

The extent to which filler particles 24 of the portion of the filler particle component are coated can be selected from numerous values, both in terms of the extent that each filler particle 24 is coated and in terms of the number of filler particles 24 that are coated. For example about 20 wt % to about 100 wt % or about 50 wt % to about 100 wt %, or about 25 wt %, 30, 35, 40, 45, 50, 55, 60, 65, 70, 75, 80, 85, 90, or 95 wt % of filler particles 24 can be at least partially coated. Of those coated filler particles 24, about 20% to about 100%, or about 80% to about 100%, or less than, equal to, or greater than 25%, 30, 35, 40, 45, 50, 55, 60, 65, 70, 75, 80, 85, 90, or 95% of a surface area of those filler particles 24 of the portion of the filler particle component is coated by first metallic layer 26.

First metallic layer 26 can range from about 0.1 wt % to about 40 wt % of the filler particle component, or about 1 wt % to about 10 wt %, or less than, equal to, or greater than 0.5 wt %, 1, 5, 10, 15, 20, 25, 30, or 35 wt %. A thickness of first metallic layer 26 can range from about 0.1 microns to about 5 microns, or from about 0.1 micron to about 1 microns, or less than, equal to, or greater than 0.5 microns, 1, 1.5, 2, 2.5, 3, 3.5, 4, or 4.5 microns.

First metallic layer 26 can be a continuous layer. This is shown in FIG. 2, where first metallic layer 26 is completely connected. Alternatively, first metallic layer 26 can be a discontinuous layer. For example first metallic layer 26 can be formed from a number of patches or globs dispersed along filler particle 24.

First metallic layer 26 includes at least one metal. The one or more metals can range from about 70 wt % to about 100 wt % of first metallic layer 26, or from about 90 wt % to about 100 wt %, less than, equal to, or greater than 75 wt %, 80, 85, 90, or 95 wt %. The at least one metal can be any suitable metal, such as elemental copper, elemental tin, elemental silver, bronze, elemental chromium, elemental titanium, or an alloy thereof. Factors that drive the decision on which metal or alloy to use can include the strength of the bond formed between first metallic layer 26 and the metallic matrix component. Additionally, a specific metal can be selected because it has a hardness that is less than that of the abrasive particle component. According to some examples, first metallic layer 26 is substantially free of elemental nickel, an alloy thereof, or a combination thereof.

In some additional examples of abrasive article 14 a second metallic layer can at least partially coat the filler particle component. The second metallic layer can coat filler particles 24 that are already at least partially coated by first metallic layer 26. That is, the second metallic layer can essentially coat first metallic layer 26 or an uncoated portion of filler particles 24 that are at least partially coated. The second metallic layer can coat filler particles 24 that are not already coated by first metallic layer 26. The second metallic layer can share many of the characteristics of first metallic layer 26 including the thickness of the layer and the weight percent it accounts for in each filler particle 24. Additionally, the second metallic layer can include any metal or alloy described herein as suitable for the first metallic layer 26, which can be the same as or different than the metal or alloy that is included in the first metallic layer 26.

As shown in FIG. 2, an interface is formed between at least one of first metallic layer 26, the metallic matrix, and the abrasive particle component. As stated herein, the performance of abrasive article 14 increases when the integrity of the connection between the components increases. Thus, the connection formed at the interface can help to improve the performance of abrasive article 14. In examples of abrasive article 14 that include the second metallic layer, the interface can be formed between at least one of first metallic layer 26, the second metallic layer, the metallic matrix component, and the abrasive particle component.

The abrasive particle component can range from about 10 vol % to about 40 vol % of abrasive article 14, or from about 20 vol % to about 30 vol %, or less than, equal to, or greater than 15 vol %, 20, 25, 30, or 35 vol %. The abrasive particle component can range from about 5 wt % to about 40 wt % of abrasive article 14, or about 10 wt % to about 20 wt %, or less than, equal to, or greater than 10 wt %, 15, 20, 25, 30, or 35 wt %.

The abrasive particle component includes a plurality of abrasive particles 22. On average, the hardness of abrasive particles 22 ranges from about 6 Mohs hardness to about 12 Mohs hardness or from about 7 Mohs hardness to about 9 Mohs hardness, or less than, equal to, or greater than 7 Mohs hardness, 8, 9, 10, or 11 Mohs hardness. Abrasive particles 22 can be selected from any of various suitable abrasive particles, such as diamond particles, cubic boron nitride particles, or a mixture thereof.

The amount of each abrasive particle 22 in the abrasive particle component can be selected from various suitable amounts. For example, about 50 wt % to about 100 wt % of abrasive particles 22 can be diamond particles, or about 90 wt % to about 100 wt %, or less than, equal to, or greater than 55 wt %, 60, 65, 70, 75, 80, 85, 90, or 95 wt %.

As shown in FIG. 2, in some circumstances it can be desirable to coat abrasive particles 22 in a similar manner to filler particles 24 with third metallic layer 28. This can promote better bonding between abrasive particles 22 and metallic matrix component and filler particles 24. The extent to which abrasive particles 22 of the abrasive particle component are coated can be selected from various values, both in terms of the extent that each abrasive particle 22 is coated and in terms of the number of abrasive particles 22 that are coated. For example about 20 wt % to about 100 wt % of each abrasive particle 22 can be at least partially coated, or about 50 wt % to about 100 wt %, or about 25 wt %, 30, 35, 40, 45, 50, 55, 60, 65, 70, 75, 80, 85, 90, or 95 wt %. Of those coated abrasive particles 22, about 20% to about 100% of a surface area of those abrasive particles 22 is coated by third metallic layer 28, or about 80% to about 100%, or less than, equal to, or greater than 25%, 30, 35, 40, 45, 50, 55, 60, 65, 70, 75, 80, 85, 90, or 95%.

Third metallic layer 28 can range from about 1 wt % to about 40 wt %, of the abrasive particle component, or about 1 wt % to about 10 wt %, or less than, equal to, or greater than 5 wt %, 10, 15, 20, 25, 30, or 35 wt %. A thickness of third metallic layer 28 can range from about 0.1 microns to about 5 microns, or from about 0.1 micron to about 1 microns, or less than equal to, or greater than 0.5 microns, 1, 1.5, 2, 2.5, 3, 3.5, 4, or 4.5 microns.

The third metallic layer 28 can be a continuous layer. This is shown in FIG. 2, where third metallic layer 28 is completely connected. Alternatively, third metallic layer 28 can be a discontinuous layer. For example third metallic layer 28 can be formed from a number of patches or globs dispersed along abrasive particle 22.

Third metallic layer 28 includes at least one metal. The metal can range from about 70 wt % to about 100 wt % of third metallic layer 28, or from about 90 wt % to about 100 wt %, less than, equal to, or greater than 75 wt %, 80, 85, 90, or 95 wt %. The specific metal can be one of many different metals including elemental copper, elemental tin, elemental silver, bronze, or an alloy thereof. Factors that drive the decision on which metal or alloy to use can include the strength of the bond formed between third metallic layer 28 and metallic matrix component. Additionally, a specific metal can be selected because it has a hardness that is less than that of abrasive particles 22. According to some examples, third metallic layer 28 is substantially free of elemental nickel, an alloy thereof, or a combination thereof.

In some additional examples of abrasive article 14, a fourth metallic layer can at least partially coat the abrasive particle component. The fourth metallic layer can coat abrasive particles 22 that are already at least partially coated by third metallic layer 28. That is, the fourth metallic layer can essentially coat third metallic layer 28 or an uncoated portion of abrasive particles 22 that are at least partially coated. Additionally, the fourth metallic layer can coat abrasive particles 22 that are not already coated by third metallic layer 28. The fourth metallic layer can share many of the characteristics of third metallic layer 28 including the thickness of the layer and the weight percent of each abrasive particle 22. Additionally, the fourth metallic layer can include any metal or alloy of third metallic layer 28. Alternatively, the fourth metallic layer can include at least one metal that is different than the metal of third metallic layer 28.

As shown in FIG. 2, an interface is formed between at least one of third metallic layer 28, the metallic matrix component, and the abrasive particle component. The performance of abrasive article 14 can increase when the integrity of the connection between the components therein increases. Thus, the connection formed at the interface can help to improve the performance of abrasive article 14. In examples of abrasive article 14 that include the fourth metallic layer, the interface can be formed between any combination of first metallic layer 26, the third metallic layer, the metallic matrix, and the filler particle component.

Similar to filler particles 24, an interface between any combination of first metallic layer 26 the second metallic layer, the metallic matrix component, the abrasive particle component, third metallic layer 28 and the fourth metallic layer can be formed. This can result in improved performance in abrasive article 14.

According to various examples, a method of using abrasive article 14 includes contacting a substrate with a wheel including abrasive article 14. The wheel can then be rotated with respect to the substrate. Material is taken away from the substrate as the wheel is rotated. Abrasive article 14 can be well suited for machining hard or brittle materials such as tungsten carbide. Such materials can be present in precursor work pieces for tools, for example, drills or milling tools.

As stated herein materials such as tungsten carbide are hard or brittle. This can increase the amount of power that is consumed by a device incorporating abrasive article 14 However, as shown herein in the Examples, less power is consumed by a device using abrasive article 14 to produce a total cut of 8 mm³/mm/sec compared to production of the same total cut under the same conditions using a corresponding article that has less or none of the at least partially coated filler particle component.

According to various embodiments a method of forming abrasive article 14 includes at least partially coating filler particles 24 of the filler particle component with first metallic layer 26 or a second metallic layer. The at least partially coated filler particles 24 are mixed with the metals of the metallic matrix component and a resin (e.g, polyamide resin) to form a mixture. After sufficient mixing, abrasive particles 22 of abrasive particle component are added to the mixture and the mixture is further mixed. Abrasive particles 22 can optionally be coated with third metallic layer 28 or a fourth metallic layer.

After sufficient mixing of the mixture can be deposited within a mold. In some examples, core 12 can be predisposed within the mold so that abrasive article 14 forms around core 12. In examples that do not include core 12, then the mold can be an open structure that the mixture is deposited in, wherein abrasive article 14 can be adhered to a core in a post-modification step.

The mold can be pressed and the temperature of the mold can be increased to about 345 degrees Celsius to about 500 degrees Celsius, or to about 410 degrees Celsius to about 430 degrees Celsius, or less than, equal to, or greater than 410 degrees Celsius, 350, 360, 370, 380, 390, 400, 410, 420 430, 440, 450, 460, 470, 480, or 490 degrees Celsius, and held. The temperature of the mold can then be reduced to a temperature of about 160 degrees Celsius to about 200 degrees Celsius, or about 170 degrees Celsius to about 190 degrees Celsius, or less than, equal to, or greater than 170 degrees Celsius, 180, or 190 degrees Celsius and held. The temperature of the mold can be then reduced to room temperature and abrasive article 14 is removed.

At least partially coating filler particles 24 or abrasive particles 22 can be a preprocessing step that differs from merely adding an uncoated filler particle or uncoated abrasive particle 22 to the metallic matrix component to form abrasive article 14.

One suitable method of coating filler particles 24 or abrasive particles 22 can be coated through precipitation coating. For example, to coat filler particles 24, they can be first exposed to an aqueous solution or slurry containing the metal. This results in a salt containing the metal to be deposited on the surface of filler particles 24. Subsequent heating decomposes the precipitating salt, which leaves behind first metallic layer 26 on the surface of filler particles 24. In other variations, a sol-gel process can be used to initiate the precipitation and deposition process. In all of these method variations, a concentration gradient of precipitation agents, pH, temperature, or other precursor decomposition can be used to obtain a first metallic layer 26 as a coating on filler particles 24.

Spraying (spray drying or spray atomization) of a metal in a molten, solution, or slurry form on to filler particles 24 is another suitable method of achieving a coated filler particle 24. Additionally, electroplating a metal to the surface of filler particles 24 can be another way to coat filler particle 24.

Another suitable method of coating filler particles 24 with the metal can be a plasma vapor method. This method can include growing the coating as a thin film from the vapor phase. In this method, filler particles 24 are exposed to the vapors of the metal under conditions that facilitate the deposition and/or growth of the metal on the surface of filler particle 24. The method places the metal under conditions such that the metal is made volatile, and the volatile metal is exposed to the surface of filler particle 24, where the vaporous metal deposits to form a metal coating.

### EXAMPLES

Unless otherwise noted, all parts, percentages, ratios, etc. in the Examples and the rest of the specification are by volume. Unless stated otherwise, all other reagents were obtained, or are available from fine chemical vendors such as Sigma-Aldrich Company, St. Louis, Mo., or may be synthesized by known methods.

Abbreviations for materials and reagents used in the examples are listed in Table 1.

TABLE 1

| Abbreviation | Description |
|---|---|
| BRO1 | Bronze powder, obtained as SPHERICAL |
| | BRONZE 60/40 from Ronald Britton, |
| | Lancashire, United Kingdom |
| BRO2 | Bronze powder containing 45% copper, |
| | 45% tin and 10% silver, obtained as |
| | BRONZE 45/45/10 from Ronald Britton |
| DIA | Resin bond diamond particles, |
| | obtained as RB-50 from Worldwide |
| | Superabrasives, LLC, Boynton Beach, |
| | Florida |
| GRA | Artificial graphite, obtained as A625 |
| | from Asbury Graphite Mills, Inc., Asnury, |
| | New Jersey |

### Example 1

Copper coated graphite particles were prepared using physical vapor deposition with magnetron sputtering. The apparatus used for the preparation of coated graphite particles was disclosed in U.S. Pat. No. 8,698,394 (McCutcheon et al.) and U.S. Pat. No. 7,727,931 (Brey et al.). A tie layer of chromium was first deposited onto graphite particles. A 99.9% pure Chromium target was dc magnetron sputtered for 4 hours at 2 kilowatts at an argon sputtering gas pressure of 10 milli torr onto 1883 grams of GRA particles. The particles were tumbled at 4 resolutions per minute during the coating process. The chamber was backfilled with argon and the chromium target was replaced by a 99.9% pure copper target. Copper was sputtered for 25 hours at 4 kilowatts power at an argon pressure of 10 millitorr. After the copper coating a thin layer of tin was sputtered using a Tin metal target for 4 hours at 1 kilowatt power at the same argon pressure. The density of the coated graphite was 2.606 grams per cubic centimeter and that of the uncoated graphite was 2.263 grams per cubic centimeter. The weight percent of metal was calculated to be 13%.

The metal matrix components BRO1 (90.6 grams), BRO2 (90.4 grams) and the copper coated graphite particles (19.1 grams) were mixed in a ball mill (Rotary Tumbler Base 2-Bar with TL-2 barrel available from C and M Topline, Goleta, Calif.) for 30 minutes to thoroughly mix them together. Upon completion of the mixing process, DIA (31.3 grams) was added to the mixture which was shaken to disperse DIA into the metal matrix particles. A hardened steel mold (101-millimeter outer diameter x 80-millimeter inner diameter, with a 12.2-millimeter thickness) was prepared and the resulting mix was added to the volume and then leveled to evenly spread and distribute the metal matrix/diamond blend to create the grinding wheel rim. The top mold plate was then added and the assembly was then pre-compacted to a pressure of 4 tons per square inch. The mold was then placed into a heated platen and compacted to a pressure of 8 tons per square inch at 400-435° C. The mold was held at this temperature and pressure for 5 min then cooled to a temperature of 180-235° C. while under pressure. The wheel was then removed from the mold.

The resulting fluting wheels comprised (by volume %) 22.3 parts of DIA, 28.9 parts of BRO1, 28.8 parts of BRO2 and 20.0 parts of copper coated graphite particles.

### Comparative Example A

A metal bonded grinding wheel obtained as STARTEC XP-P+DC from Tyrolit Schleifmittelwerke Swarovski K.G., Schwaz, Austria.

### Comparative Example B

A grinding wheel obtained as WENDT NAXOFLUTEMAX from 3M Company, Saint Paul, Minn.

### Comparative Example C

A hybrid fluting wheel obtained as D320 630HJ from 3M Company, Saint Paul, Minn.

### Comparative Example D

A grinding wheel obtained as PARADIGM from Saint Gobain, Courbevoie, France.

### Grinding Test

Each of the sample grinding wheels were trued and dressed off-line before use as follows. The samples were mounted on a steel arbor and balanced. The sample was trued with a silicon carbide wheel of 120 grit, H grade and vitrified bond, commonly used for such processes. The sample was rotated at about 1/10 the surface speed of the silicon carbide wheel that was run at approximately 5000 surface feet per minute. While the sample wheel was rotating, it was trued at 0.001 inch depth of cut and 20 inch per minute traverse rate until the wheel was considered true. Each sample was also dressed with a silicon carbide wheel of 220 mesh to expose the grit for grinding. Dressing with a 220 mesh white aluminum oxide stick was completed at the beginning of all grinds to start from same reference point.

The wheels were then tested by grinding straight flutes on a 10% Cobalt, Tungsten Carbide rod (0.5-inch diameter and 4-inch long, obtained from Sandvik, Stockholm, Sweden). The grinding was performed with TX7+ grinder obtained from ANCA Company, Melbourne, Australia. Two test conditions were used. In both conditions, wheel speed was 18 meters per second, depth of cut was 4 millimeters and width of cut was 3.75 millimeters. In Test Condition 1, material removal rate Q′_{w} (an indicative of how many mm³ of material are removed by 1 mm wheel width per second) was 8 mm³/mm/sec, and infeed rate was 120 millimeters per minute. In Test Condition 2, Q′_{w} was set as 10.7 mm³/mm/sec, and infeed rate was 160 millimeters per minute.

The test data obtained under Test Condition 1 is summarized in Table 1 and FIG. 1 below.

TABLE 1
Test Condition 1

| | Wheel | | | | |
|---|---|---|---|---|---|
| | COMPAR- | | COMPAR- | COMPAR- | COMPAR- |
| | ATIVE | | ATIVE | ATIVE | ATIVE |
| | EXAM- | EXAM- | EXAM- | EXAM- | EXAM- |
| Flute | PLE A | PLE 1 | PLE B | PLE D | PLE C |
| # | Spindle Power (Kilowatt) | | | | |
| 1 | 0.90 | 0.89 | 0.92 | 0.89 | 1.28 |
| 2 | 0.96 | 0.92 | 1.00 | 0.96 | 1.47 |
| 3 | 1.04 | 0.98 | 1.06 | 1.02 | 1.68 |
| 4 | 1.12 | 1.03 | 1.13 | 1.06 | 1.89 |
| 5 | 1.19 | 1.09 | 1.17 | 1.11 | 2.03 |
| 6 | 1.26 | 1.12 | 1.20 | 1.14 | 2.08 |
| 7 | 1.35 | 1.12 | 1.25 | 1.20 | 2.25 |
| 8 | 1.34 | 1.14 | 1.34 | 1.27 | 2.30 |
| 9 | 1.41 | 1.20 | 1.38 | 1.34 | 2.35 |
| 10 | 1.53 | 1.25 | 1.44 | 1.37 | 2.44 |
| 11 | 1.57 | 1.27 | 1.46 | 1.45 | 2.40 |
| 12 | 1.63 | 1.29 | 1.51 | 1.50 | 2.51 |
| 13 | 2.18 | 1.31 | 1.55 | 1.56 | 2.51 |
| 14 | 2.19 | 1.35 | 1.68 | 1.62 | 2.54 |
| 15 | 2.27 | 1.38 | 1.99 | 1.67 | 2.59 |
| 16 | 2.23 | 1.36 | 1.81 | 1.73 | 2.53 |
| 17 | 2.40 | 1.36 | 2.20 | 1.80 | 2.61 |
| 18 | 2.50 | 1.34 | 2.22 | 1.85 | 2.59 |
| 19 | 0.76 | 1.34 | 2.37 | 2.35 | 2.55 |
| 20 | 0.80 | 1.36 | 2.42 | 2.45 | 2.62 |

The test data obtained under Test Condition 2 is summarized in Table 2 and FIG. 2 below.

TABLE 2
Test Condition 2

Wheel

| | | | | |
|---|---|---|---|---|
| | | COMPAR- | COMPAR- | COMPAR- |
| | | ATIVE | ATIVE | ATIVE |
| | EXAM- | EXAM- | EXAM- | EXAM- |
| Flute | PLE 1 | PLE B | PLE D | PLE C |

| | |
|---|---|
| # | Spindle Power (Kilowatt) |

| | | | | |
|---|---|---|---|---|
| 1 | 1.05 | 1.20 | 1.07 | 1.60 |
| 2 | 1.11 | 1.27 | 1.16 | 1.95 |
| 3 | 1.17 | 1.33 | 1.20 | 2.07 |
| 4 | 1.25 | 1.40 | 1.30 | 2.16 |
| 5 | 1.28 | 1.44 | 1.34 | 2.34 |
| 6 | 1.27 | 1.51 | 1.40 | 2.30 |
| 7 | 1.30 | 1.58 | 1.47 | 2.45 |
| 8 | 1.32 | 1.63 | 1.51 | 2.43 |
| 9 | 1.37 | 1.70 | 1.58 | 2.50 |
| 10 | 1.39 | 2.05 | 1.61 | 2.55 |
| 11 | 1.43 | 2.02 | 1.66 | 2.48 |
| 12 | 1.46 | 2.20 | 1.73 | 2.60 |
| 13 | 1.49 | 2.21 | 1.79 | 2.60 |
| 14 | 1.52 | 2.30 | 2.05 | 2.60 |
| 15 | 1.55 | 2.32 | 2.22 | 2.63 |
| 16 | 1.58 | 2.23 | 2.26 | 2.57 |
| 17 | 1.65 | 2.40 | 2.34 | 2.66 |
| 18 | 1.65 | 2.42 | 2.41 | 2.63 |
| 19 | 1.68 | 2.50 | 2.47 | 2.58 |
| 20 | 1.72 | 2.53 | 2.50 | 2.71 |

Various modifications and alterations of this disclosure may be made by those skilled in the art without departing from the scope and spirit of this disclosure, and it should be understood that this disclosure is not to be unduly limited to the illustrative embodiments set forth herein.

### Additional Embodiments

The following exemplary embodiments are provided, the numbering of which is not to be construed as designating levels of importance:

Embodiment 1 provides an abrasive article comprising:

a metallic matrix component;

an abrasive particle component dispersed within the metallic matrix component; and

a filler particle component dispersed within the metallic matrix component;

wherein a portion of the filler particle component is at least partially coated by a first metallic layer and a hardness of the abrasive particle component is greater than a hardness of the filler particle component.

Embodiment 2 provides the abrasive article according to Embodiment 1, wherein the metallic matrix component is about 10 wt % to about 50 wt % of the abrasive article.

Embodiment 3 provides the abrasive article according to any one of Embodiments 1 or 2, wherein the metallic matrix component is about 20 wt % to about 40 wt % of the abrasive article.

Embodiment 4 provides the abrasive article according to any one of Embodiments 1-3, wherein the metallic matrix component is about 40 vol % to about 90 vol % of the abrasive article.

Embodiment 5 provides the abrasive article according to any one of Embodiments 1-4, wherein the metallic matrix component is about 50 vol % to about 80 vol % of the abrasive article.

Embodiment 6 provides the abrasive article according to any one of Embodiments 1-5, wherein the metallic matrix component comprises a plurality of metallic particles.

Embodiment 7 provides the abrasive article according to Embodiment 6, wherein a hardness of about 50 wt % to about 100 wt % of the metallic particles is lower than the hardness of the abrasive particle component.

Embodiment 8 provides the abrasive article according to any one of Embodiments 6 or 7, wherein a hardness of about 90 wt % to about 100 wt % of the metallic particles is lower than the hardness of the abrasive particle component.

Embodiment 9 provides the abrasive article according to any one of Embodiments 6-8, wherein the hardness of the metallic particles ranges from about 2 Mohs hardness to about 8 Mohs hardness.

Embodiment 10 provides the abrasive article according to any one of Embodiments 6-9, wherein the hardness of the metallic particles ranges from about 4 Mohs hardness to about 6 Mohs hardness.

Embodiment 11 provides the abrasive article according to any one of Embodiments 6-10, wherein the metallic particles comprise elemental tin, elemental silver, elemental copper, bronze, or alloys thereof.

Embodiment 12 provides the abrasive article according to any one of Embodiments 6-11, wherein the metallic particles comprises bronze.

Embodiment 13 provides the abrasive article according to any one of Embodiments 6-12, wherein the metallic particles are 100 wt % bronze.

Embodiment 14 provides the abrasive article according to Embodiment 13, wherein the bronze is about 10 vol % to about 60 vol % of the abrasive article.

Embodiment 15 provides the abrasive article according to any one of Embodiments 13 or 14, wherein the bronze is about 20 vol % to about 50 vol % of the abrasive article.

Embodiment 16 provides the abrasive article according to any one of Embodiments 13-15, wherein the bronze is about 10 wt % to about 50 wt % of the abrasive article.

Embodiment 17 provides the abrasive article according to any one of Embodiments 13-16, wherein the bronze is about 20 wt % to about 30 wt % of the abrasive article.

Embodiment 18 provides the abrasive article according to any one of Embodiments 13-17, wherein the bronze is at least one of 60/40 bronze 50/50 bronze, and 40/60 bronze.

Embodiment 19 provides the abrasive article according to any one of Embodiments 1-18, wherein the metallic matrix component comprises bronze and an alloy of elemental silver, elemental copper, and elemental tin.

Embodiment 20 provides the abrasive article according to Embodiment 19, wherein the alloy is about 10 vol % to about 50 vol % of the abrasive article.

Embodiment 21 provides the abrasive article according to any one of Embodiments 19 or 20, wherein the alloy is about 20 vol % to about 40 vol % of the abrasive article.

Embodiment 22 provides the abrasive article according to any one of Embodiments 19-21, wherein the alloy is about 10 wt % to about 50 wt % of the abrasive article.

Embodiment 23 provides the abrasive article according to any one of Embodiments 19-22, wherein the alloy is about 20 wt % to about 40 wt % of the abrasive article.

Embodiment 24 provides the abrasive article according to any one of Embodiments 19-23, wherein the elemental silver is about 1 wt % to about 20 wt % of the alloy.

Embodiment 25 provides the abrasive article according to any one of Embodiments 19-24, wherein the elemental silver is about 5 wt % to about 15 wt % of the alloy.

Embodiment 26 provides the abrasive article according to any one of Embodiments 19-25, wherein the elemental copper is about 30 wt % to about 60 wt % of the alloy.

Embodiment 27 provides the abrasive article according to any one of Embodiments 19-26, wherein the elemental copper is about 40 wt % to about 50 wt % of the alloy.

Embodiment 28 provides the abrasive article according to any one of Embodiments 19-27, wherein the elemental tin is about 30 wt % to about 60 wt % of the alloy.

Embodiment 29 provides the abrasive article according to any one of Embodiments 19-28, wherein the elemental tin is about 40 wt % to about 50 wt % of the alloy.

Embodiment 30 provides the abrasive article according to any one of Embodiments 1-29, wherein the filler particle component is about 5 vol % to about 40 vol % of the abrasive article.

Embodiment 31 provides the abrasive article according to any one of Embodiments 1-30, wherein the filler particle component is about 15 vol % to about 30 vol % of the abrasive article.

Embodiment 32 provides the abrasive article according to any one of Embodiments 1-31, wherein the filler particle component is about 2 wt % to about 20 wt % of the abrasive article.

Embodiment 33 provides the abrasive article according to any one of Embodiments 1-32, wherein the filler particle component is about 5 wt % to about 10 wt % of the abrasive article.

Embodiment 34 provides the abrasive article according to any one of Embodiments 1-33, wherein the filler particle component comprises a plurality of filler particles.

Embodiment 35 provides the abrasive article according to Embodiment 34, wherein the hardness of the filler particles ranges from about 0.5 Mohs hardness to about 8 Mohs hardness.

Embodiment 36 provides the abrasive article according to any one of Embodiments 34 or 35, wherein the hardness of the filler particles ranges from about 0.5 Mohs hardness to about 4 Mohs hardness.

Embodiment 37 provides the abrasive article according to any one of Embodiments 34-36, wherein the filler particles are graphite particles, boron nitride particles, glass particles, silicon nitride particles, binder coke particles, or mixtures thereof.

Embodiment 38 provides the abrasive article according to any one of Embodiments 34-37, wherein about 50 wt % to about 100 wt % of the filler particles are graphite particles.

Embodiment 39 provides the abrasive article according to any one of Embodiments 34-38, wherein about 90 wt % to about 100 wt % of the filler particles are graphite particles.

Embodiment 40 provides the abrasive article according to any one of Embodiments 34-39, wherein the portion of filler particle component that is at least partially coated by the first metallic layer is about 1 wt % to about 100 wt % of the filler particles.

Embodiment 41 provides the abrasive article according to any one of Embodiments 34-40, wherein the portion of filler particle component that is at least partially coated by the first metallic layer is about 50 wt % to about 100 wt % of the filler particles.

Embodiment 42 provides the abrasive article according to any one of Embodiments 34-41, wherein about 20% to about 100% of a surface area of each filler particle of the portion of the filler particle component that is at least partially coated by the first metallic layer is coated by the first metallic layer.

Embodiment 43 provides the abrasive article according to any one of Embodiments 34-42, wherein about 80% to about 100% of a surface area of each filler particle of the portion of the filler particle component that is at least partially coated by the first metallic layer is coated by the first metallic layer.

Embodiment 44 provides the abrasive article according to any one of Embodiments 1-43, wherein the first metallic layer is about 0.1 wt % to about 40 wt % of the filler particle component.

Embodiment 45 provides the abrasive article according to any one of Embodiments 1-44, wherein the first metallic layer is about 1 wt % to about 10 wt % of the filler particle component.

Embodiment 46 provides the abrasive article according to any one of Embodiments 1-45, wherein a thickness of the first metallic layer ranges from about 0.1 microns to about 5 microns.

Embodiment 47 provides the abrasive article according to any one of Embodiments 1-46, wherein a thickness of the first metallic layer ranges from about 0.1 micron to about 1 microns.

Embodiment 48 provides the abrasive article according to any one of Embodiments 1-47, wherein the first metallic layer is a continuous layer.

Embodiment 49 provides the abrasive article according to any one of Embodiments 1-48, wherein the first metallic layer is a discontinuous layer.

Embodiment 50 provides the abrasive article according to any one of Embodiments 1-49, wherein the first metallic layer comprises a metal.

Embodiment 51 provides the abrasive article according to Embodiment 50, wherein the metal is about 70 wt % to about 100 wt % of the first metallic layer.

Embodiment 52 provides the abrasive article according to any one of Embodiments 50 or 51, wherein the metal is about 90 wt % to about 100 wt % of the first metallic layer.

Embodiment 53 provides the abrasive article according to any one of Embodiments 50-52, wherein the metal is elemental copper, elemental tin, elemental silver, bronze, or an alloy thereof.

Embodiment 54 provides the abrasive article according to any one of Embodiments 50-53, wherein the first metallic layer is substantially free of elemental nickel an alloy thereof, or a combination thereof.

Embodiment 55 provides the abrasive article according to any one of Embodiments 1-54, further comprising a second metallic layer at least partially coating the filler particle component.

Embodiment 56 provides the abrasive article according to Embodiment 55, wherein the second metallic layer includes metal different than the metal of the first metallic layer.

Embodiment 57 provides the abrasive article according to any one of Embodiments 1-56, further comprising an interface between at least one of the first metallic layer, the metallic matrix, and the abrasive particle component.

Embodiment 58 provides the abrasive article according to Embodiment 55, further comprising an interface between at least one of the first metallic layer, the second metallic layer, the metallic matrix, and the abrasive particle component.

Embodiment 59 provides the abrasive article according to any one of Embodiments 1-58, wherein the abrasive particle component is about 10 vol % to about 40 vol % of the abrasive article.

Embodiment 60 provides the abrasive article according to any one of Embodiments 1-59, wherein the abrasive particle component is about 20 vol % to about 30 vol % of the abrasive article.

Embodiment 61 provides the abrasive article according to any one of Embodiments 1-60, wherein the abrasive particle component is about 5 wt % to about 40 wt % of the abrasive article.

Embodiment 62 provides the abrasive article according to any one of Embodiments 1-61, wherein the abrasive particle component is about 10 wt % to about 20 wt % of the abrasive article.

Embodiment 63 provides the abrasive article according to any one of Embodiments 1-62, wherein the abrasive particle component comprises a plurality of abrasive particles.

Embodiment 64 provides the abrasive article according to Embodiment 63, wherein the hardness of the abrasive particles ranges from about 6 Mohs hardness to about 12 Mohs hardness.

Embodiment 65 provides the abrasive article according to any one of Embodiments 63 or 64, wherein the hardness of the metallic particles ranges from about 7 Mohs hardness to about 9 Mohs hardness.

Embodiment 66 provides the abrasive article according to any one of Embodiments 63-65, wherein the abrasive particles are at least one of diamond particles and cubic boron nitride particles.

Embodiment 67 provides the abrasive article according to any one of Embodiments 63-66, wherein about 50 wt % to about 100 wt % of the abrasive particles are diamond particles.

Embodiment 68 provides the abrasive article according to any one of Embodiments 63-67, wherein about 90 wt % to about 100 wt % of the abrasive particles are diamond particles.

Embodiment 69 provides the abrasive article according to any one of Embodiments 63-68, wherein a portion of the abrasive particles comprise a third metallic layer at least partially coating a portion of the abrasive particles.

Embodiment 70 provides the abrasive article according to Embodiment 69, wherein the portion of abrasive particles is about 20 wt % to about 100 wt % of the abrasive particles.

Embodiment 71 provides the abrasive article according to any one of Embodiments 69 or 70, wherein the portion of abrasive particles is about 50 wt % to about 100 wt % of the abrasive particles.

Embodiment 72 provides the abrasive article according to any one of Embodiments 69-71, wherein about 20% to about 100% of a surface area of each abrasive particle of the portion of abrasive particles is coated by the third metallic layer.

Embodiment 73 provides the abrasive article according to any one of Embodiments 69-72, wherein about 80% to about 100% of a surface area of each abrasive particle of the portion of abrasive particles is coated by the third metallic layer.

Embodiment 74 provides the abrasive article according to any one of Embodiments 69-73, wherein the third metallic layer is a continuous layer.

Embodiment 75 provides the abrasive article according to any one of Embodiments 69-74, wherein the third metallic layer is a discontinuous layer.

Embodiment 76 provides the abrasive article according to any one of Embodiments 69-75, wherein the third metallic layer comprises a metal.

Embodiment 77 provides the abrasive article according to Embodiment 76, wherein the metal is about 70 wt % to about 100 wt % of the third metallic layer.

Embodiment 78 provides the abrasive article according to any one of Embodiments 76 or 77, wherein the metal is about 90 wt % to about 100 wt % of the third metallic layer.

Embodiment 79 provides the abrasive article according to any one of Embodiments 76-78, wherein the metal is elemental copper, elemental tin, elemental silver, bronze, or a mixture thereof.

Embodiment 80 provides the abrasive article according to any one of Embodiments 76-79, wherein the third metallic layer is substantially free of elemental nickel or an alloy thereof.

Embodiment 81 provides the abrasive article according to any one of Embodiments 69 80, wherein a thickness of the third metallic layer ranges from about 0.1 microns to about 5 microns.

Embodiment 82 provides the abrasive article according to any one of Embodiments 69-81, wherein a thickness of the third metallic layer ranges from about 0.1 micron to about 1 microns.

Embodiment 83 provides the abrasive article according to any one of Embodiments 69-82, further comprising a fourth metallic layer at least partially coating the third metallic layer.

Embodiment 84 provides the abrasive article according to Embodiment 83, wherein the fourth metallic layer comprises a metal, wherein the fourth metallic layer has a different composition than the third metallic layer.

Embodiment 85 provides the abrasive article according to any one of Embodiments 83 or 84, further comprising an interface between at least one of the first metallic layer, the second metallic layer, the metallic matrix, the abrasive particle component, the third metallic layer, and the fourth metallic layer.

Embodiment 86 provides the abrasive article according to any one of Embodiments 1-85, wherein

the metallic matrix component comprises bronze and an alloy of elemental silver, elemental copper, and elemental tin;

the filler particles comprises graphite; and

the abrasive particles comprise diamond.

Embodiment 87 provides the abrasive article according to any one of Embodiments 1-86, wherein:

the metallic matrix component is about is about 30 wt % to about 60 wt % of the abrasive article;

the filler particle component is about 5 wt % to about 20 wt % of the abrasive article; and

the filler particle component is about 5 wt % to about 20 wt % of the abrasive article.

Embodiment 88 provides the abrasive article according to any one of Embodiments 1-87, wherein the article is a wheel.

Embodiment 89 provides a method of using the abrasive article according to any one of Embodiments 1-88, comprising:

contacting a substrate with the wheel; and

rotating the wheel with respect to the substrate.

Embodiment 90 provides the method according to Embodiment 89, wherein less power is consumed by the article to produce a total cut of 8 mm³/mm/sec compared production of the same total cut under the same conditions using a corresponding article that is free of the at least partially coated filler particle component.

Embodiment 91 provides the method according to any one of Embodiments 89 or 90, wherein the substrate is a drill bit precursor.

Embodiment 92 provides the method according to any one of Embodiments 89-91, wherein the substrate is comprises tungsten carbide.

Embodiment 93 provides a method of forming the abrasive article according to any one of Embodiments 1-92, comprising:

at least partially coating the filler particle component with the first metallic layer;

mixing the at least partially coated filler particle component, the metallic matrix, and a resin to form a mixture;

adding the abrasive particle component to the mixture and further mixing the mixture; and

contacting the mixture with a mold.

Embodiment 94 provides the method according to Embodiment 93, wherein the resin comprises a polyamide resin.

Embodiment 95 provides the method according to any one of Embodiments 93 or 94, further comprising pressing the mold.

Embodiment 96 provides the method according to Embodiment 95, further comprising increasing the temperature of the mold.

Embodiment 97 provides the method according to Embodiment 96, wherein the temperature is increased to about 345 degrees Celsius to about 500 degrees Celsius.

Embodiment 98 provides the method according to any one of Embodiments 96 or 97, wherein the temperature is increased to about 410 degrees Celsius to about 430 degrees Celsius.

Embodiment 99 provides the method according to any one of Embodiments 96-98, further comprising reducing the temperature of the mold.

Embodiment 100 provides the method according to Embodiment 99, wherein the temperature of the mold is decreased to about 160 degrees Celsius to about 235 degrees Celsius.

Embodiment 101 provides the method according to any one of Embodiments 99 or 100, wherein the temperature of the mold is decreased to about 170 degrees Celsius to about 190 degrees Celsius.

Embodiment 102 provides the method according to any one of Embodiments 93-101, wherein the filler particle component is coated with the metal by plasma vapor coating.

1. An abrasive article comprising:
a metallic matrix component;
an abrasive particle component dispersed within the metallic matrix component;
a filler particle component dispersed within the metallic matrix component; and
wherein a portion of the filler particle component is at least partially coated by a first metallic layer and a hardness of the abrasive particle component is greater than a hardness of the filler particle component.

2. The abrasive article of claim 1, wherein the metallic matrix component comprises a plurality of metallic particles.

3. The abrasive article of claim 2, wherein a hardness of about 50 wt % to about 100 wt % of the metallic particles is lower than the hardness of the abrasive particle component.

4. The abrasive article of claim 1, wherein the metallic matrix component comprises bronze and an alloy of elemental silver, elemental copper, and elemental tin.

5. The abrasive article of claim 1, wherein the filler particle component comprises a plurality of filler particles.

6. The abrasive article of claim 5, wherein the filler particles are graphite particles, boron nitride particles, glass particles, silicon nitride particles, binder coke particles, or mixtures thereof.

7. The abrasive article of claim 1 wherein the portion of filler particle component that is at least partially coated by the first metallic layer is about 1 wt % to about 100 wt % of the filler particles.

8. The abrasive article of claim 1, wherein about 20% to about 100% of a surface area of each filler particle of the portion of the filler particle component that is at least partially coated by the first metallic layer is coated by the first metallic layer.

9. The abrasive article of claim 1, wherein the first metallic layer comprises a metal.

10. The abrasive article of claim 9, wherein the metal is elemental copper, elemental tin, elemental silver, bronze, or an alloy thereof

11. The abrasive article of claim 1, further comprising a second metallic layer at least partially coating the filler particle component.

12. The abrasive article of claim 1, wherein the abrasive particle component comprises a plurality of abrasive particles.

13. The abrasive article of claim 12, wherein the abrasive particles are at least one of diamond particles and cubic boron nitride particles.

14. A method of forming the abrasive article of claim 1, comprising:
at least partially coating the filler particle component with the first metallic layer;
mixing the at least partially coated filler particle component, the metallic matrix, and a resin to form a mixture;
adding the abrasive particle component to the mixture and further mixing the mixture; and
contacting the mixture with a mold.

15. The method of claim 14, wherein the filler particle component is coated with the metal by plasma vapor coating.
